(19) United States
(12) Patent Application Publication
(10) Pub. No.: US 2003/0003199 A1
(43) Pub. Date: Jan. 2, 2003

(54) Method and apparatus for utilizing tomatoes to produce salsa

(76) Inventor: Ralph P. Perez, Phoenix, AZ (US)

Correspondence Address: Tod R. Nissle, Esq., TOD R. NISSLE, P.C., P.O. Box 55630, Phoenix, AZ, 85078, US

(21) Appl. No.: 09/896,712

(22) Filed: Jun. 29, 2001

(51) Int. Cl. A23B 4/00

(52) U.S. Cl. 426/120

(57) ABSTRACT

A method and apparatus for producing salsa utilizes tomatoes in combination a condiment mixture. The condiment mixture is dry and is sealed in a package prior to use. The dry condiment mixture includes chili pepper, dry garlic, sea salt, oregano leaves, and cumin seeds. The salsa can be used as a decongestant.

This invention relates to the packaging of condiments and to the preparation of food products.

In another respect, the invention relates to a method and apparatus for packaging a condiment mixture.

In a further respect, the invention relates to a method and apparatus for producing salsa without requiring the use and preparation of fresh vegetables.

Salsa is a favorite food of many individuals and is often eaten with corn chips and other so-called “Mexican food”. Salsa is typically prepared by cutting up tomatoes, onion greens, and other fresh vegetables and by then mixing these vegetables together and adding seasoning. Salsa has been made for decades using the foregoing conventional procedure. While this conventional procedure often produces salsa which has an excellent taste and consistency, it is time consuming to buy the vegetables, take out a cutting board, cut up the vegetables, mix the vegetables together, add seasoning to the vegetable mixture, and clean up the cutting board and utensils utilizing in making the salsa. Another disadvantage of the conventional procedure is that the fresh vegetables used to make conventional salsa also have a short shelf life.

Accordingly, it would be highly desirable to provide a method and apparatus for making salsa which would not require the purchase and preparation of fresh vegetables.

Therefore, it is a principal object of the instant invention to provide an improved method and apparatus for making a food product.

A further object of the invention is to provide an improved method for making salsa which simplifies and speeds the making of salsa by only requiring the use of pre-packaged foods and condiments.

Another object of the invention is to provide an improved method and apparatus for packing salsa condiments to facilitate making different kinds of salsa.

These and other, further and more specific objects and advantages of the invention will be apparent to those skilled in the art from the following detailed description thereof, taken in conjunction with the drawings, in which:

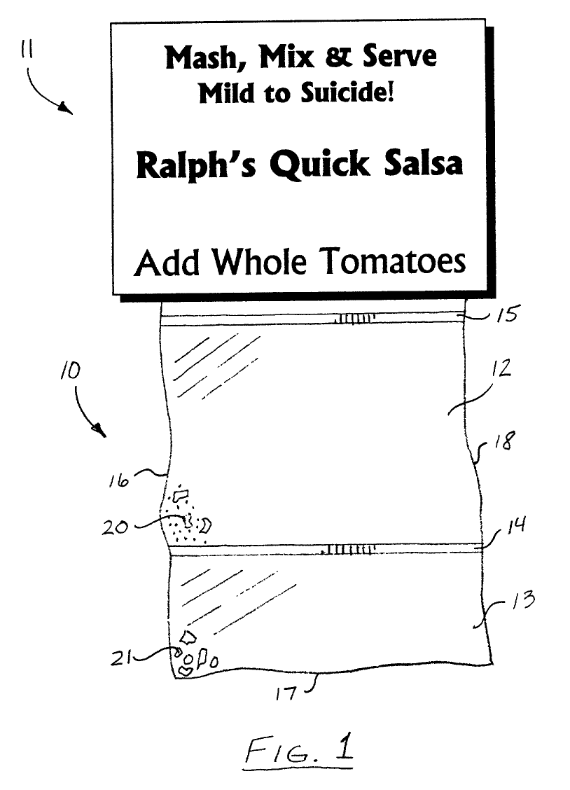

FIG. 1 illustrates a condiment mixture and packaging constructed in accordance with the principles of the invention; and,

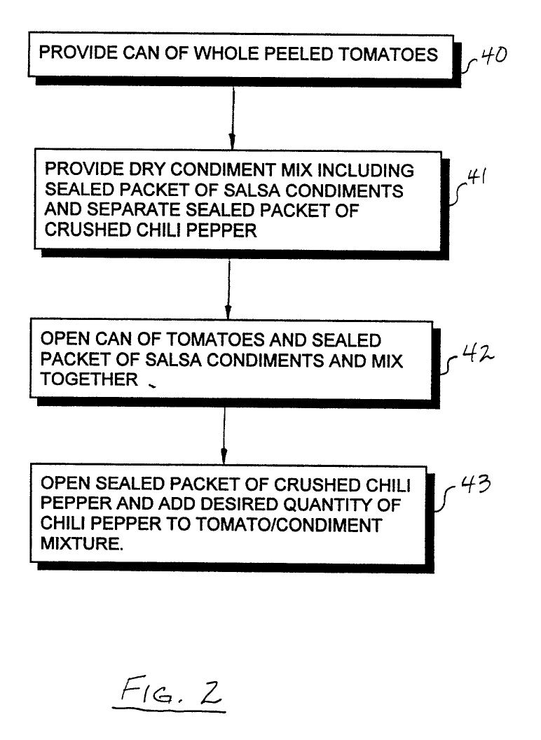

FIG. 2 illustrates a method for making salsa in accordance with the invention by only utilizing components which each have a long shelf life and by only utilizing dry condiments.

Briefly, in accordance with the invention, I provide an improved method of making salsa. The method includes the steps of providing peeled tomatoes; providing a dry condiment mixture including pieces of dried garlic, pieces of dried chili pepper, sea salt, pieces of dried oregano leaf, and pieces of cumin seed; and, mixing together the tomatoes and dry condiment mixture.

In another embodiment of the invention, I provide, in combination with tomatoes, the improvements for making a salsa mixture. The improvements comprising a dry condiment mixture. The dry mixture includes pieces of dried garlic, pieces of dried chili pepper, salt, pieces of dried oregano leaf, and pieces of cumin seed.

In a further embodiment of the invention, I provide a condiment apparatus for making salsa with tomatoes. The apparatus includes a polymer package including a first sealed compartment and a second sealed compartment attached to the first sealed compartment; and, a dry condiment mixture in the first sealed compartment. The dry condiment mixture includes pieces of dried garlic, pieces of dried chili pepper, salt, pieces of dried oregano leaf, and pieces of cumin seeds. A dry condiment is in the second sealed compartment. The condiment in the second sealed compartment comprises pieces of chili pepper.

In another embodiment of the invention, I provide an improved method to remove mucous from the nasal passage of an individual. The method includes the steps of providing the salsa noted above comprising an admixture of tomatoes and a dry condiment mixture; and, having the individual consume the salsa for a period of at least five minutes.

Turning now to the drawings, which illustrate the presently preferred embodiments of the invention for the purpose of illustrating the practice thereof, and not by way of limitation of the scope of the invention, FIG. 1 illustrates a condiment mixture and packaging constructed in accordance with the principles of the invention and including a package 10 made from a polymer or other material and including a label 11 affixed to the top of package 10 with adhesive or other desired fastening means. Package 10 includes sealed compartments or pockets 12 and 13. The polymer material comprising each pocket 12, 13 is heat-welded or otherwise bonded together along strips 14, 15. The seal along strip 14 sealingly separates pocket 12 from pocket 13 and prevents condiments in pocket 12 from entering pocket 13, and vice-versa. The seal along strip 15 sealingly closes the top of pocket 12 and prevents condiments from escaping from the top of pocket 12. Interconnected peripheral edges 16, 17, 18 are also sealed together such that pockets 12 and 13 are each completely sealed along all peripheral edges of the pocket. This facilitates keeping the condiment(s) in each pocket 12, 13 fresh. It is preferred, although not necessary, that the polymer material or other material used to make pockets 12, 13 is relatively impermeable to oxygen and other atmospheric gases.

In order that the condiment mixture used in the practice of the invention has a long shelf life, it is important that the mixture be comprised only of dry condiments. According to individuals who have used the condiment mixture of the presently preferred embodiment of the invention, the condiment mixture, when combined with peeled canned tomatoes (or with fresh tomatoes), produces a salsa having a pleasing, delicious taste.

The dry condiment mixture includes pieces of dried chili peppers; pieces of dried garlic; salt, preferably—but not necessarily—sea salt; pieces of dried oregano leaves; and pieces of cumin seeds.

The chili pepper pieces preferably, but not necessarily, include both seeds and pieces of the husk or body of one or more chili peppers. The chili pepper pieces are preferably crushed, but can be simply cut or otherwise produced.

The pieces of garlic preferably, but not necessarily, comprise dry granulated garlic. Garlic salt is not preferred because it makes the condiment mixture of the invention too salty.

The additional minerals found in sea salt are believed to improve the taste of the condiment mixture of the invention. Consequently, sea salt is preferred, although any conventional table salt (sodium chloride) can be utilized. Salt is also important in the dry condiment mixture of the invention because it functions as a preservative both of the condiment mixture and of the salsa produced utilizing the condiment mixture.

The oregano utilized can comprise any marjoram, including pieces of dried leaves of origanum vulgare, which has spikes of pinkish flowers or of dried leaves of majorama hortensis.

The cumin utilized comprises pieces of the seedlike fruit (hereafter “seeds”) of cumin, which makes up the genus Cuminum in the family Apiaceae. Since the taste of cumin resembles caraway seeds in taste, pieces of caraway seed can also be used as “cumin seeds” in conjunction with or in place of pieces of seed from Cuminum.

The condiment mixture in one packet 12 is sufficient to be mixed with a large 28 oz can of tomatoes (preferably peeled) to make a batch of salsa. The condiment mixture in packet 12 includes 0.46 gram of pieces of dried chili pepper, 10.2 grams of granulated garlic, 3.42 grams of sea salt granules, 1.9 grams of dried oregano leaves, and 0.83 gram of pieces of cumin seeds. The cumin seed piece preferably, but not necessarily, comprise a powder. The amount of dried chili pepper can be in the range of 0.1 to 8.0 gram(s), preferably 0.26 to 6.0 gram(s). The amount of dry garlic can be in the range of 5.0 to 16.0 grams, preferably 8.0 to 12.0 grams. The amount of dried oregano leaf can be in the range of 0.5 to 5.0 gram(s), preferably 1.0 to 3.0 gram(s). The amount of sea salt can be in the range of 1.0 to 6.0 gram(s), preferably 2.4 to 4.4 grams. The amount of cumin seed can be in the range of 0.25 to 5.0 gram(s), preferably 0.5 to 2.0 gram(s).

Each piece or granule of sea salt, chili pepper, oregano leaf, etc. comprising the condiment mixture of the invention can have any desired size. Most pieces of condiment in the mixture, however, have a maximum length of about one-half inch or less.

While the cumin seed pieces presently comprise a powder, the garlic and sea salt are granulated. If desired, garlic powder and salt powder can be utilized. The oregano leaves and chili pepper pieces can also be added as a powder, but it is preferred that the majority of the oregano leaf pieces and of the and chili pepper pieces each have a maximum length in the range of one-sixteenth of an inch to one-half of an inch. The oregano leaf pieces and chili pepper pieces add contrast and texture to salsa made with the condiment mixture of the invention. The oregano leaf pieces and chili pepper pieces usually have in irregular shape, and the length of the piece varies.

The use of a dry condiment mixture is critical in the practice of the invention. Each condiment is termed “dry”, and is dry to the touch, even though each condiment likely has a small amount of retained moisture, typically in the range of about 0.25% to 5.0% by weight. Fresh vegetables are not utilized in the condiment mixture of the invention, although after admixing the condiment mixture of the invention and tomatoes an individual is free to add to the resulting salsa mixture any desired supplemental ingredients. The condiment mixture of the invention functions to produces a conventional salsa taste while eliminating the majority of the work and expense necessary to produce salsa in accordance with conventional salsa recipes. The ability of a dry condiment mixture to replicate in large part the taste and consistency of salsa made using conventional salsa recipes was unexpected because of the long reliance on various chopped fresh vegetables.

In FIG. 1, packet 13 includes additional pieces of chili pepper 21. A user can, if he or she wishes, add some or all of the chili pepper 21 in packet 13 to the salsa mixture produced by admixing condiment mixture 20 with a can of tomatoes. Adding all or a portion of pepper 21 makes the mixture “hotter”. The adjoining of packet 13 to packet 12 is an important feature of the invention because it is not necessary to market one condiment mixture that is “mild” (not too many chili peppers), to market another condiment mixture that is “medium” (an average proportion of chili peppers), to market another condiment mixture that is “hot” (an above average proportion of chili peppers), and to market yet another condiment mixture that is “really hot” (a large proportion of chili peppers). Instead, only one condiment mixture is marketed, a mild mixture along with additional chili peppers which can be added in whole or in part to adjust how “hot” the resulting salsa mixture will be.

The dry condiment mixture of the invention can be utilized with canned tomatoes or fresh tomatoes. It is preferred to utilize the dry condiment mixture with canned tomatoes because then each ingredient (condiments and tomatoes) used to make salsa has a long shelf life and need not be chopped or otherwise specially prepared. The ingredients need only be put in a bowl and mixed.

FIG. 2 illustrates a method of making salsa in accordance with the invention, including the step 40 of providing a can of whole peeled tomatoes. In step 41, a dry condiment mix is provided, including a sealed packet of salsa condiment and a separate sealed packet of crushed chili peppers. In step 42, the can of tomatoes and the packet 12 of condiment mixture 20 are opened. The entire condiment mixture 20 and the entire contents of the can of tomatoes are mixed together to produce a tomato/condiment salsa mixture. In step 43, the packet 13 of crushed chili pepper 21 is opened and a desired quantity of chili pepper 21 from the packet 13 is added to the tomato/condiment salsa mixture until the mixture is as “hot” to the taste as desired.

Salsa prepared utilizing tomatoes and the powder condiment of the invention is found to have the unexpected effect of functioning as a decongestant and facilitating the clearance of mucous from the nasal passage.

### EXAMPLE 1

Salsa is prepared by mixing a 28 ounce can of whole tomatoes with a condiment package including 0.46 gram of pieces of dried chili pepper, 10.2 grams of granulated garlic, 3.42 grams of sea salt granules, 1.9 grams of dried oregano leaves (Origanum vulgare), and 0.83 gram of pieces of cumin seeds.

A 53 year white Caucasian male patient has a sinus condition which produces mucous filling the nasal cavity at the point where the back of the nasal cavity is adjacent and enters the patient's throat. The patient consumes salsa for five minutes. After consuming the salsa mucous no long blocks the nasal cavity at the entrance to the throat.

### EXAMPLE 2

Salsa is prepared by mixing a 28 ounce can of whole tomatoes with a condiment package including 0.46 gram of pieces of dried chili pepper, 10.2 grams of granulated garlic, 3.42 grams of sea salt granules, 1.9 grams of dried oregano leaves (Origanum vulgare), and 0.83 gram of pieces of cumin seeds.

A 21 year African American woman patient has a sinus condition which produces mucous filling the nasal cavity at the point where the back of the nasal cavity is adjacent and enters the patient's the throat. The patient consumes salsa for five minutes. After consuming the salsa mucous no long blocks the nasal cavity at the entrance to the throat.

### EXAMPLE 3

Example 1 is repeated, except that instead of eating salsa, the patient eats a bowl of oatmeal, a banana, and bacon. After consuming this food, mucous still fills the patient's nasal cavity at the point where the back of the nasal cavity is adjacent the patient's throat.

### EXAMPLE 4

Example 2 is repeated, except that instead of eating salsa, the patient eats a bowl of oatmeal, a banana, and bacon. After consuming this food, mucous still fills the patient's nasal cavity at the point where the back of the nasal cavity is adjacent the patient's throat.

### EXAMPLE 5

Example 1 is repeated, except that the patient consumes salsa for only two minutes. After the salsa is consumed, mucous still fills the patient's nasal passage adjacent the patient's throat.

### EXAMPLE 6

Example 2 is repeated, except that the patient eats salsa for three minutes. After the patient finishes eating the salsa, mucous still substantially fills the patient's nasal passage adjacent the back of the patient's throat.

### EXAMPLE 7

Example 1 is repeated, except that the patient consumes salsa for ten. Similar results are obtained.

### EXAMPLE 8

Example 1 is repeated, except that the patient eats salsa for ten minutes. Similar results are obtained.

### EXAMPLE 9

Example 1 and 2 are repeated except that Majorana hortensis is used in place of Origanum vulgare. Similar results are obtained.

Having described the invention in such terms as to enable those of skilled in the art to understand and practice the invention, and having described the presently preferred embodiments thereof, I claim:

1. A method of making salsa, comprising the steps of
(a) providing peeled tomatoes;
(b) providing a dry condiment mixture including
(i) pieces of dried garlic,
(ii) pieces of dried chili pepper,
(iii) sea salt,
(iv) pieces of dried oregano leaf, and
(v) pieces of cumin seed; and
(c) mixing the tomatoes and dry condiment mixture.

2. In combination with tomatoes, the improvements for making a salsa mixture, said improvements comprising a dry condiment mixture including
(a) pieces of dried garlic,
(b) pieces of dried chili pepper,
(c) salt,
(d) pieces of dried oregano leaf, and
(e) pieces of cumin seed.

3. A condiment apparatus for making salsa with tomatoes, said apparatus including
(a) a polymer package including
(i) a first sealed compartment, and
(ii) a second sealed compartment attached to said first sealed compartment;
(b) a dry condiment mixture in said first sealed compartment, said dry condiment mixture including
(i) pieces of dried garlic,
(ii) pieces of dried chili pepper,
(iii) salt,
(iv) pieces of dried oregano leaf, and
(v) pieces of cumin seeds; and,
(c) a dry condiment in said second sealed compartment, said condiment in said second sealed compartment comprising pieces of chili pepper.

4. A method to remove mucous from the nasal passage of an individual, comprising the steps (a)
providing the salsa of claim 1; and
(b) having the individual consume the salsa for a period of at least five minutes.
